(19) United States
(12) Patent Application Publication
(10) Pub. No.: US 2023/0226698 A1
(43) Pub. Date: Jul. 20, 2023

(54) ROBOT TELEOPERATION CONTROL DEVICE, ROBOT TELEOPERATION CONTROL METHOD, AND STORAGE MEDIUM

(71) Applicant: HONDA MOTOR CO., LTD., Tokyo (JP)

(72) Inventors: Tomohiro Chaki, Wako-shi (JP); Tomoki Watabe, Wako-shi (JP); Yili Dong, Wako-shi (JP); Akira Mizutani, Wako-shi (JP); Anirudh reddy Kondapally, Wako-shi (JP)

(21) Appl. No.: 18/079,916

(22) Filed: Dec. 13, 2022

(30) Foreign Application Priority Data
Jan. 19, 2022 (JP) 2022-006498

(51) Int. Cl. B25J 9/16; B25J 13/00; B25J 13/08

(52) U.S. Cl. CPC B25J 9/1697; B25J 13/006; B25J 13/085; B25J 13/088; B25J 9/163; B25J 9/1653; B25J 9/1664

(57) ABSTRACT

A robot teleoperation control device includes a first acquisition unit that acquires operator state information of a state of an operator who operates a robot, an intention estimation unit that estimates an intention of the operator to cause the robot to perform a motion on the basis of the operator state information, a second acquisition unit that acquires at least one of geometric information and dynamic information of the object, an operation method determination unit that determines a method of operating the object based on the estimated motion intention of the operator, and a control amount determination unit that determines a method of operating the robot and force during operation from the information acquired by the second acquisition unit and information determined by the operation method determination unit and reflects the result in a control instruction.

### CROSS-REFERENCE TO RELATED APPLICATION

Priority is claimed on Japanese Patent Application No. 2022-006498, filed Jan. 19, 2022, the content of which is incorporated herein by reference.

### BACKGROUND OF THE INVENTION

### Field of the Invention

The present invention relates to a robot teleoperation control device, a robot teleoperation control method, and a storage medium.

### Description of Related Art

A technique in which an operator remotely operates and controls a robot has been proposed (see, for example Japanese Patent No. 6476358).

### SUMMARY OF THE INVENTION

However, in real-world work, dynamic information is important in addition to geometric information. For example, force to be applied changes depending on the mass and Young's modulus of an object. In a case where the object is known, a control instruction can be generated so that contact force and force required for gravity compensation can be exerted on the basis of dynamic information given in advance. In a case where an unknown object is handled in a teleoperated robot, it is difficult for an operator to immediately consider the gravity compensation, Young's modulus, and friction of the object, which is an obstacle to work. For this reason, in the related art, it is difficult for a teleoperated robot to grasp or operate various objects with an appropriate force.

The present invention was contrived in view of the above problem, and an object thereof is to provide a robot teleoperation control device, a robot teleoperation control method, and a storage medium that make it possible for a teleoperated robot to operate various objects with an appropriate force.

In order to solve the above problem and achieve such an object, the present invention adopts the following aspects.

(1) According to an aspect of the present invention, there is provided a robot teleoperation control device including: a first acquisition unit that acquires operator state information of a state of an operator who operates a robot capable of grasping an object in robot teleoperation control in which the operator remotely operates the robot; an intention estimation unit that estimates an intention of the operator to cause the robot to perform a motion on the basis of the operator state information; a second acquisition unit that acquires at least one of geometric information and dynamic information of the object; an operation method determination unit that determines a method of operating the object based on the estimated motion intention of the operator; and a control amount determination unit that determines a method of operating the robot and force during operation from the information acquired by the second acquisition unit and information determined by the operation method determination unit and reflects the result in a control instruction.

(2) In the above aspect (1), the second acquisition unit may acquire at least one of a shape, mass, Young's modulus, rigidity, and frictional force of the object.

(3) In the above aspect (1) or (2), the second acquisition unit may acquire environmental information including an image including the object and position information of the object, and sensor information detected by a sensor provided in the robot to detect information related to the motion of the robot.

(4) In any one of the above aspects (1) to (3), the second acquisition unit may acquire at least one of the geometric information and dynamic information of the object through at least one of estimating an external force using a force sensor and a torque sensor provided in the robot, classification using a trained learning model, and referring to a database that stores information relating to the object.

(5) In any one of the above aspects (1) to (4), the intention estimation unit may estimate a name of the object, operation content for the object, and a point of contact between the robot and the object when the object is operated.

(6) According to an aspect of the present invention, there is provided a robot teleoperation control method including: causing a first acquisition unit to acquire operator state information of a state of an operator who operates a robot capable of grasping an object in robot teleoperation control in which the operator remotely operates the robot; causing an intention estimation unit to estimate an intention of the operator to cause the robot to perform a motion on the basis of the operator state information; causing a second acquisition unit to acquire at least one of geometric information and dynamic information of the object; causing an operation method determination unit to determine a method of operating the object based on the estimated motion intention of the operator; and causing a control amount determination unit to determine a method of operating the robot and force during operation from the information acquired by the second acquisition unit and information determined by the operation method determination unit and reflect the result in a control instruction.

(7) According to an aspect of the present invention, there is provided a computer readable non-transitory storage medium that stores a program for causing a computer to function as the robot teleoperation control device according to any one of the above aspects (1) to (5).

According to the above aspects (1) to (7), a teleoperated robot can operate various objects with an appropriate force. According to the above aspects (1) to (7), improvement in work efficiency and an increase in the number of types of work are expected.

### BRIEF DESCRIPTION OF THE DRAWINGS

FIG. 1 is a diagram illustrating an outline of a robot teleoperation control system according to an embodiment and an outline of work.

FIG. 2 is a diagram illustrating a configuration example of a robot.

FIG. 3 is a diagram illustrating a configuration example of the robot teleoperation control system including a robot teleoperation control device according to the embodiment.

FIG. 4 is a diagram illustrating an example of information stored in an object information DB according to the embodiment.

FIG. 5 is a diagram illustrating a configuration example of a hand according to the embodiment.

FIG. 6 is a diagram illustrating an example of a state in which the robot grasps an object.

FIG. 7 is a diagram illustrating an example of a work object.

FIG. 8 is a sequence diagram illustrating an example of a processing procedure of the robot teleoperation control system according to the embodiment.

### DETAILED DESCRIPTION OF THE INVENTION

Hereinafter, an embodiment of the present invention will be described with reference to the accompanying drawings. In the drawings used in the following description, the scale of each member is appropriately changed in order to make each member recognizable.

### [Outline]

First, an outline of work and processing which are performed by a robot teleoperation control system will be described.

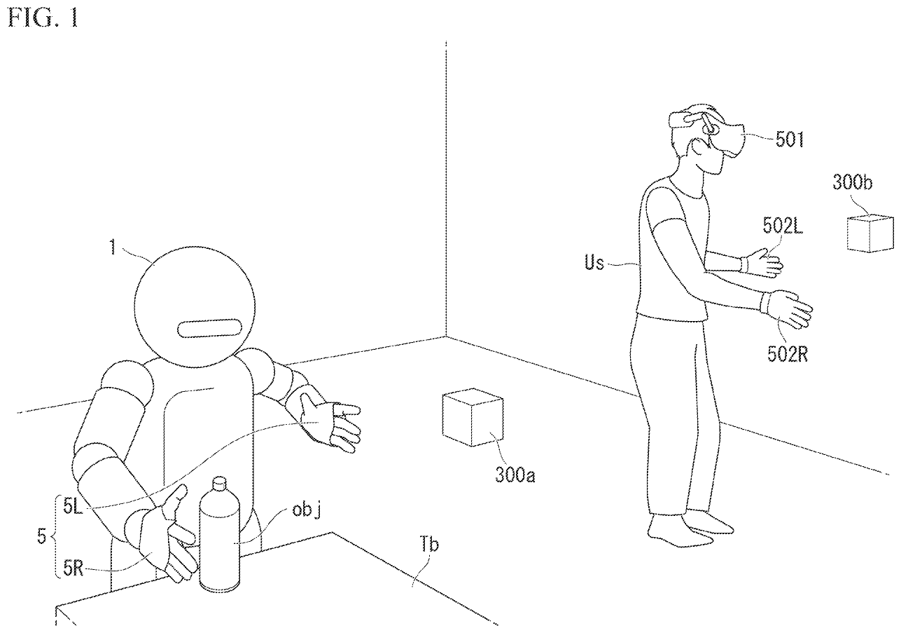

FIG. 1 is a diagram illustrating an outline of a robot teleoperation control system according to the present embodiment and an outline of work. As shown in FIG.

1, an operator Us is wearing, for example, a head mounted display (HMD) 501, a controller 502 (502L, 502R), and the like. An environmental sensor 300 (300a, 300b) is installed in a work space. The environmental sensor 300 may be attached to a robot 1. The robot 1 has a hand 5 (5L, 5R). The environmental sensor 300 includes, for example, an RBG camera and a depth sensor. The operator Us remotely operates the robot 1 by moving the hand or fingers wearing the controller 502 while viewing an image displayed on the HMD 501. In the example of FIG. 1, the operator Us remotely operates the robot 1 to grasp a PET bottle obj on a table Tb. In the remote operation, the operator Us cannot directly view the motion of the robot 1, but can indirectly view the video of the robot 1 side through the HMD 501.

In the present embodiment, physical information relating to an object to be operated is acquired or estimated using at least one of geometric information acquired from the environmental sensor 300 and dynamic information detected by, for example, a sensor of the robot 1. In the present embodiment, for example, the intention of the operator is estimated on the basis of information obtained from the HMD 501 and the controller worn by the operator Us, the environmental sensor 300, the sensor provided in the robot 1, and the like. In the present embodiment, an operation method, force during operation, and the like are generated on the basis of the estimated physical information of the object and the intention of the operator.

### [Configuration Example of Robot]

Next, a configuration example of the robot 1 will be described.

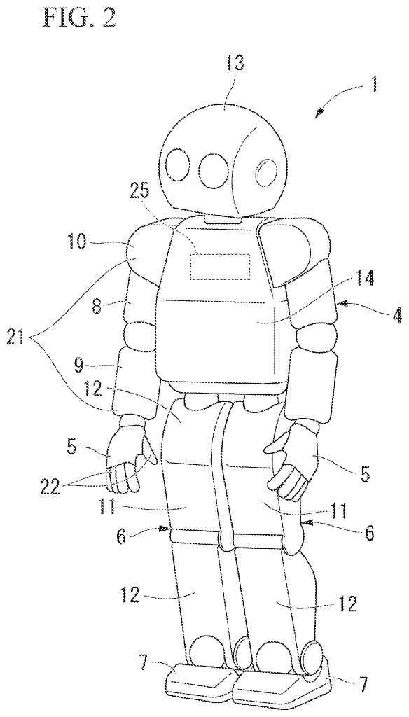

FIG. 2 is a diagram illustrating a configuration example of the robot. As shown in FIG. 2, the robot 1 includes, for example, arms 4, hands (grasp parts) 5, legs 6, feet 7, upper arms 8, forearms 9, shoulders 10, thighs 11, lower legs 12, a head 13, and a body 14. A control unit 25 is provided in, for example, the body 14.

For example, shoulder joints, elbow joints, and hand joints are provided with arm actuators 21. Hands and fingers are provided with hand joint actuators 22. The robot 1 is configured with the actuators 21 and 22 provided with encoders and torque sensors. For example, the inner and lateral fingers of the hand 5 are provided with force sensors.

The configuration shown in FIG. 2 is an example, and there is no limitation thereto. For example, although a bipedal walking robot is shown as an example of the robot 1, the robot 1 is only required to be provided with at least an arm and a hand.

### [Configuration Example of Robot Teleoperation Control System]

Next, a configuration example of a robot teleoperation control system 100 will be described.

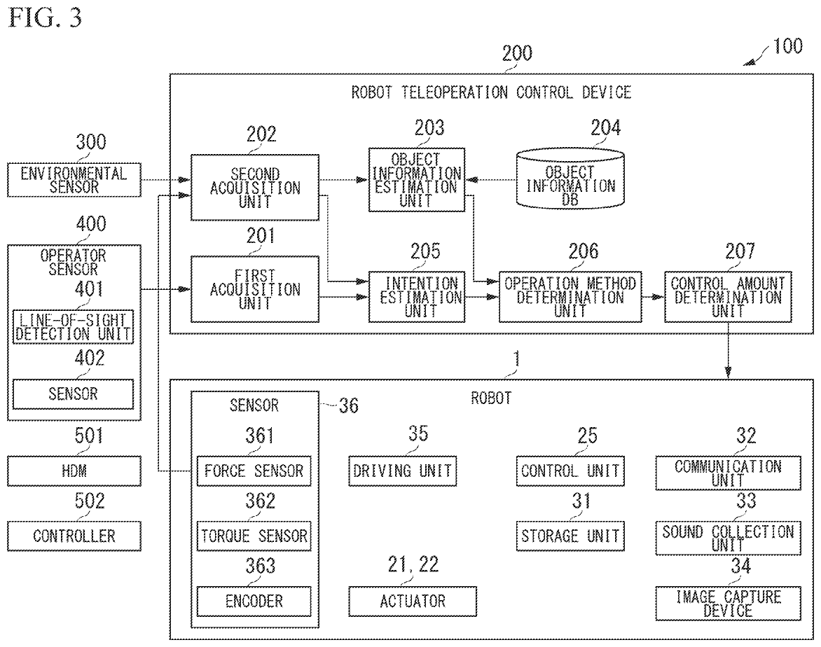

FIG. 3 is a diagram illustrating a configuration example of a robot teleoperation control system including a robot teleoperation control device according to the present embodiment. As shown in FIG. 3, the robot teleoperation control system 100 includes, for example, the robot 1, a robot teleoperation control device 200, the environmental sensor 300, an operator sensor 400, the HMD 501, and the controller 502.

The robot 1 includes, for example, the actuator 21, the actuator 22, the control unit 25, a storage unit 31, a communication unit 32, a sound collection unit 33, an image capture device 34, a driving unit 35, and a sensor 36. The sensor 36 includes, for example, a force sensor 361, a torque sensor 362, and an encoder 363.

The robot teleoperation control device 200 includes, for example, a first acquisition unit 201, a second acquisition unit 202, an object information estimation unit 203 (second acquisition unit), an object information DB 204, an intention estimation unit 205, an operation method determination unit 206, and a control amount determination unit 207.

The operator sensor 400 includes, for example, a line-of-sight detection unit 401 and a sensor 402. The line-of-sight detection unit 401 and the sensor 402 are provided in, for example, the HMD 501. The sensor 402 is provided in, for example, the controller 502.

The robot teleoperation control device 200 and the environmental sensor 300 are connected to each other through, for example, a wireless or wired network. The robot teleoperation control device 200 and the operator sensor 400 are connected to each other through, for example, a wireless or wired network. The robot teleoperation control device 200 and the robot 1 are connected to each other through, for example, a wireless or wired network. The robot teleoperation control device 200 and the environmental sensor 300 may be directly connected to each other without going through a network. The robot teleoperation control device 200 and the operator sensor 400 may be directly connected to each other without going through a network. The robot teleoperation control device 200 and the environmental sensor 300 may be directly connected to each other without going through a network. The robot teleoperation control device 200 and the robot 1 may be directly connected to each other without going through a network.

### [Function Example of Robot Teleoperation Control System]

Next, a function example of the robot teleoperation control system 100 will be described with reference to FIG. 3.

The HMD 501 includes, for example, an image display unit, the line-of-sight detection unit 401, the sensor 402, a communication unit, a control unit, a storage unit, and the like. The state image of the robot 1 received from the robot teleoperation control device 200 is displayed. The HMD 501 detects the movement of the line of sight of an operator, the movement of the head of the operator, and the like, and transmits the detected operator state information to the robot teleoperation control device 200.

The line-of-sight detection unit 401 detects the line of sight of the operator and outputs operator state information including the detected line-of-sight information (operator sensor value) to the robot teleoperation control device 200.

In a case where the HMD 501 includes the sensor 402, the sensor 402 is, for example, an acceleration sensor, a gyroscope, or the like, detects the movement and inclination of the head of the operator, and outputs operator state information including the detected head movement information (operator sensor value) to the robot teleoperation control device 200.

The controller 502 includes, for example, the sensor 402, a control unit, a communication unit, a feedback means, and the like. The controller 502 is, for example, a tactile data glove which is worn on the hand of the operator. The controller 502 uses the sensor 402 to detect the orientation, the motion of each finger, and the motion of the hand, and transmits the detected operator state information to the robot teleoperation control device 200.

The sensor 402 is, for example, an acceleration sensor, a gyroscope sensor, a magnetic force sensor, or the like. In a case where the sensor 402 including a plurality of sensors is provided, the motion of each finger is tracked by, for example, two sensors. The sensor 402 detects operator arm information (operator sensor value, operator state information) which is information relating to the posture and position of the arm of the operator such as the orientation, the motion of each finger and the motion of the hand, and outputs operator state information including the detected operator arm information to the robot teleoperation control device 200. The operator arm information includes information on the entire human arm such as hand position/posture information, finger angle information, elbow position/posture information, and information on tracking of the motion of each part.

The environmental sensor 300 is installed, for example, at a position where work of the robot 1 can be photographed and detected. The environmental sensor 300 may be provided in the robot 1 or may be attached to the robot 1. Alternatively, a plurality of environmental sensors 300 may be provided, and may be installed in the work environment and attached to the robot 1 as shown in FIG. 1. The environmental sensor 300 is, for example, an RGB camera or a depth sensor. The environmental sensor 300 may be a motion capture device and may detect position information of an object through motion capture. The environmental sensor 300 may be a distance sensor. The environmental sensor 300 transmits a captured image and a sensor value detected by a depth sensor as environmental information to the robot teleoperation control device 200. The environmental sensor 300 may detect the position information of the object using the captured image and the sensor value, and transmit the detection result as environmental information to the robot teleoperation control device 200. Data which is transmitted by the environmental sensor 300 may be, for example, a point cloud having position information.

### (Function Example of Robot)

In a case where the robot 1 is not remotely operated, its behavior is controlled in accordance with control of the control unit 25. In a case where the robot 1 is remotely operated, its behavior is controlled in accordance with grasp plan information generated by the robot teleoperation control device 200.

The control unit 25 controls the driving unit 35 on the basis of a control instruction which is output from the robot teleoperation control device 200. The control unit 25 performs sound recognition processing (such as utterance section detection, sound source separation, sound source localization, noise suppression, or sound source identification) on an acoustic signal collected by the sound collection unit 33. In a case where the result of sound recognition includes a motion instruction for the robot 1, the control unit 25 may control the motion of the robot 1 on the basis of a motion instruction based on sound. The control unit 25 performs image processing (such as edge detection, binarization processing, feature amount extraction, image enhancement processing, image extraction, or pattern matching processing) on an image captured by the environmental sensor 300 on the basis of information stored in the storage unit 31. The control unit 25 refers to the object information DB 204 and extracts information relating to the object from the captured image through image processing. The object information includes, for example, information such as the name of the object, the shape of the object, the weight of the object, the Young's modulus of the object, and the frictional force on the surface of the object. The control unit 25 creates a robot state image on the basis of the motion state information of the robot 1 and transmits the created robot state image to the HMD 501 through the robot teleoperation control device 200. The control unit 25 generates feedback information and transmits the generated feedback information to the controller 502 through the robot teleoperation control device 200.

The storage unit 31 stores, for example, a program, a threshold, and the like which are used for control by the control unit 25.

The sound collection unit 33 is, for example, a microphone array including a plurality of microphones. The sound collection unit 33 outputs the collected acoustic signal to the control unit 25. The sound collection unit 33 may have a sound recognition processing function. In this case, the sound collection unit 33 outputs the sound recognition result to the control unit 25.

The image capture device 34 is attached to, for example, the head 13 or the body 14 of the robot 1. The image capture device 34 may be the environmental sensor 300. The image capture device 34 outputs the captured image to the control unit 25.

The driving unit 35 drives each part (arms, fingers, feet, head, torso, waist, and the like) of the robot 1 in accordance with the control of the control unit 25. The driving unit 35 includes, for example, actuators, gears, artificial muscles, and the like.

The sensor 36 may be, for example, an acceleration sensor, a gyroscope sensor, a magnetic force sensor, or the like. The sensor 36 is attached to joints, the head, hands, fingers, and the like of the robot 1. The sensor 36 outputs the detected result to the control unit 25 and the robot teleoperation control device 200.

### (Function Example of Robot Teleoperation Control Device)

The robot teleoperation control device 200 acquires operator state information which is the state of an operator who operates the robot 1, and estimates the intention of the operator to cause the robot 1 to perform a motion on the basis of the acquired operator state information. The robot teleoperation control device 200 acquires at least one of geometric information and dynamic information of an object, and determines a method of operating the object based on the estimated motion intention of the operator. The robot teleoperation control device 200 determines a method of operating the robot 1 and force during operation from at least one of the acquired geometric information and dynamic information of the object and the information determined by the operation method determination unit, and reflects the result in a control instruction.

The first acquisition unit 201 acquires information such as line-of-sight information of the operator, the movement and position of the wrist, the movement and position of the palm, and the movement and position of the finger from the operator sensor 400. The first acquisition unit 201 outputs the acquired information to the intention estimation unit 205.

The second acquisition unit 202 acquires force, torque, position information of the arm and hand, and the like from the sensor 36 of the robot 1. The second acquisition unit 202 acquires environmental information from the environmental sensor 300. The second acquisition unit 202 outputs the acquired information to the object information estimation unit 203 and the intention estimation unit 205.

The object information estimation unit 203 uses the information acquired by the second acquisition unit 202 to refer to information stored in the object information DB 204 and to estimate at least one of geometric information and dynamic information of an object to be operated. For example, before the robot 1 grasps or touches an object, that is, before operation, the object information estimation unit 203 uses the environmental information acquired from the environmental sensor 300 to refer to the information stored in the object information DB 204 and to estimate the name, shape, weight, Young's modulus, friction, and the like of the object. In this case, the object information estimation unit 203 estimates the name, shape, and weight of the object on the basis of the environmental information, and acquires the Young's modulus and friction associated therewith from the object information DB 204. For example, in a case where the robot 1 starts work, the object information estimation unit 203 also uses a detection value detected by the sensor 402 of the robot 1 to estimate the name, shape, weight, Young's modulus, friction, and the like of the object.

The object information DB 204 is a database and stores information relating to an object (object name, shape, weight, Young's modulus, friction, and the like). The object information DB 204 may store a template and a trained model.

The intention estimation unit 205 estimates the intention of a worker using the information acquired by the first acquisition unit 201 and the information acquired by the second acquisition unit 202. The intention estimation unit 205 estimates the motion intention of the operator using at least one of the line-of-sight information, the operator arm information, and the head movement information among the information acquired from the HMD 501 and the controller 502. The intention estimation unit 205 may estimate the intention using the environmental sensor value as well. An intention estimation method will be described later.

The operation method determination unit 206 determines a method of operating an object based on the estimated motion intention of the operator. For example, the operation method determination unit 206 determines the operation method by referring to, for example, a template stored in its own unit or the object information DB 204. The operation method determination unit 206 may select the operation method by inputting it into, for example, a trained model stored in its own unit or the object information DB 204. The operation method determination unit 206 obtains, for example, a point of contact of the fingers of the robot 1 with respect to an object at which the object can be stably grasped without being dropped, from constraint conditions such as selected motion classification and object shape, physical parameters such as estimated object friction and weight, and torque that can be output by the robot 1. The operation method determination unit 206 may, for example, make a correction operation using a joint angle calculated from these as a target value. The operation method determination unit 206 controls the finger joint angle, torque, and the like in real time so as to eliminate, for example, an error between the target value/parameter estimation value and a value observed from the sensor 36 of the robot 1 in a case where an operation according to the target value is performed. Thereby, according to the present embodiment, an object can be grasped stably and continuously without being dropped.

The control amount determination unit 207 determines a method of operating a robot and force during operation from the information acquired by the second acquisition unit 202 and information determined by the operation method determination unit, and reflects the result in a control instruction. The control amount determination unit 207 transmits the reflected control instruction to the robot 1.

### (Intention Estimation Method)

Here, an example of the intention estimation method will be described.

The intention estimation unit 205 estimates the motion intention of the operator using, for example, a grasp taxonomy method (see, for example Reference Document 1).

In the present embodiment, the operator state is classified by classifying the posture, that is, grasp posture, of the operator or the robot 1 using, for example, the grasp taxonomy method, and the motion intention of the operator is estimated. The intention estimation unit 205 inputs, for example, the operator state information into a trained model stored in the intention estimation unit 205, and estimates the motion intention of the operator. In the present embodiment, the motion intention of the operator can be estimated with a good degree of accuracy by estimating the intention through the classification of the grasp posture. Other methods may be used to classify the grasp posture.

Reference Document 1: Thomas Feix, Javier Romero, et al., “The GRASP Taxonomy of Human Grasp Types” IEEE Transactions on Human-Machine Systems (Volume: 46, Issue: 1, Feb. 2016), IEEE, p66-77

The intention estimation unit 205 may make an integrated estimation using the line of sight and the movement of the arm. In this case, the intention estimation unit 205 may input line-of-sight information, hand movement information, and position information of an object on a table into a trained model and estimate the motion intention of the operator.

The intention estimation unit 205 first estimates the grasped object on the basis of, for example, the operator state information. The intention estimation unit 205 estimates the grasped object on the basis of, for example, the line-of-sight information. Next, the intention estimation unit 205 estimates the posture of the hand of the operator on the basis of the estimated object to be grasped.

Alternatively, the intention estimation unit 205 first estimates the posture of the hand of the operator on the basis of, for example, the operator state information. Next, the intention estimation unit 205 estimates an object to be grasped from the estimated posture of the hand of the operator. For example, in a case where three objects are placed on a table, the intention estimation unit 205 estimates which of the three objects is a grasp candidate on the basis of the posture of the hand.

The intention estimation unit 205 may estimate the future trajectory of the hand intended by the operator in advance on the basis of the operator state information and the state information of the robot 1.

The intention estimation unit 205 may estimate an object to be operated and the position of the object using the result of detection performed by the sensor 400, the result of image processing of an image captured by the environmental sensor 300, and the like.

### (Example of Information Stored in Object Information DB)

Here, an example of information stored in the object information DB 204 will be described.

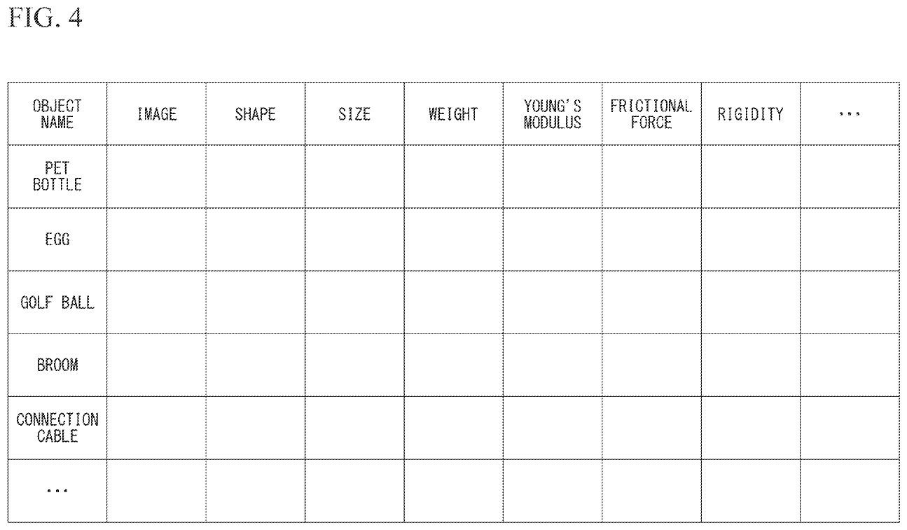

FIG. 4 is a diagram illustrating an example of information stored in the object information DB according to the present embodiment. As shown in FIG. 4, the object information DB 204 stores, for example, an object name in association with an image, shape, size, weight, Young's modulus, frictional force, and rigidity. Some objects have different Young's moduli and frictional forces at different locations. In such a case, the Young's modulus, frictional force, and the like are stored in association with each location.

The example shown in FIG. 4 is an example, and there is no limitation thereto. The object information DB 204 may not store shape and weight. In this case, for example, the object information estimation unit 203 may estimate the shape and weight of an object using a trained learning model stored in the object information estimation unit 203. In this case, the learning is performed by inputting the environmental information acquired by the environmental sensor 300 and training data into the learning model.

### (Configuration Example of Hand)

Here, a configuration example of the hand 5 will be described.

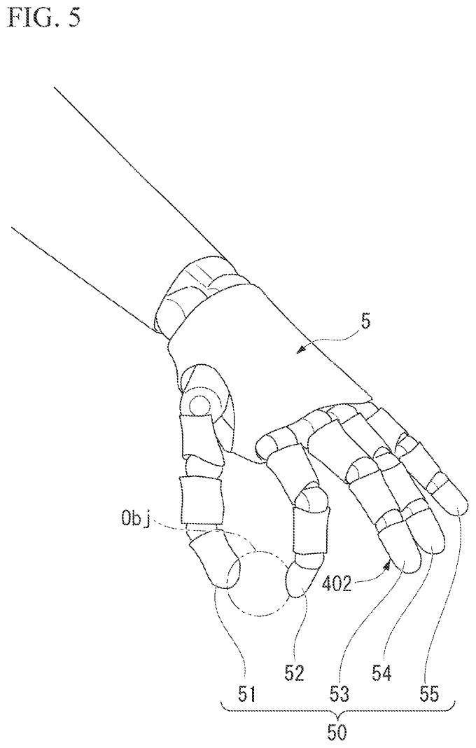

FIG. 5 is a diagram illustrating a configuration example of a hand according to the present embodiment. FIG. 5 is also diagram illustrating an example in which the hand 5 of the robot 1 grasps an object Obj with fingers 50 (51 to 55). The hand 5 has at least two or more fingers 50. For example, the sensor 402 is attached to the belly of each finger. The sensor 402 detects force and frictional force, for example, when it comes into contact with an object.

### (Work Content)

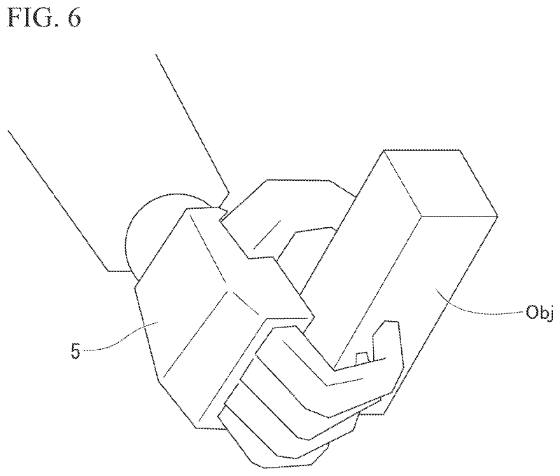

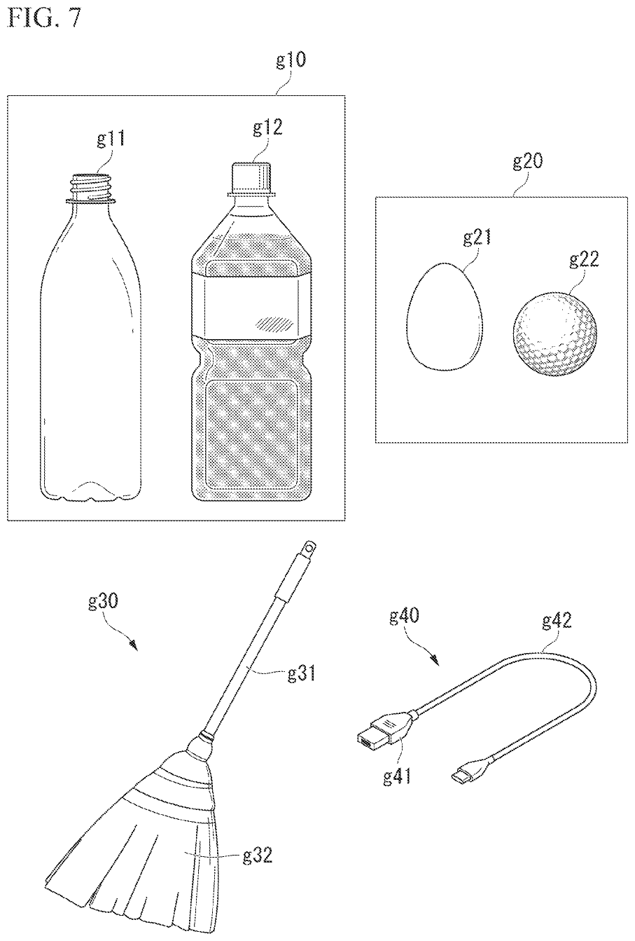

Here, an example of work which is performed by the robot 1 through remote operation described with reference to FIGS. 6 and 7. FIG. 6 is a diagram illustrating an example of a state in which the robot grasps an object. FIG. 7 is a diagram illustrating an example of a work object.

Examples of work performed by the robot 1 include grasping an object, placing an object on a hand, pressing an object (such as a button), opening a lid (of a PET bottle, a jar, or the like), and the like. In such work, it may not be possible to perform the work well with the name, shape, and position of an object alone, for example, as information obtained from a captured image. In a case where the object is a PET bottle as in a square g10 in FIG. 7, it may be an empty PET bottle g11 or may be a PET bottle g12 containing the contents. In this case, for example, the weight and Young's modulus are different. In a case where the object is spherical as in a square g20 in FIG. 7, it may be an egg g21 or may be a golf ball g22. In this case, for example, the Young's modulus and rigidity are different. In a case where the object is a broom g30, for example, the Young's modulus, rigidity, and frictional force are different between a grasping handle g31 and an ear tip g32. In a case where the object is a connection cable g40, for example, the Young's modulus is different between a grasping connector g41 and a cable g42. In this way, it may be easier to perform work using geometric information and dynamic information depending on the work.

In a case where an object is grasped, for example, as shown in FIG. 6, the object is recognized as a PET bottle, and control is performed using parameters in which the shape and the weight when the contents are contained are associated with the name of the PET bottle. In this case, even though a PET bottle containing the contents can be grasped, controlling an empty PET bottle with its setting causes the PET bottle to be crushed, and thus work is not able to be performed well. In a case where the object is a spherical shape g20, mixture of an egg and a golf ball exhibits a similar shape, but grasping with the parameters of the golf ball may cause the egg to be crushed.

Therefore, in the present embodiment, geometric information and dynamic information of an object are acquired to generate a contact force target appropriate for various objects.

### (Processing Procedure Example)

Next, an example of a processing procedure of the robot teleoperation control system 100 will be described.

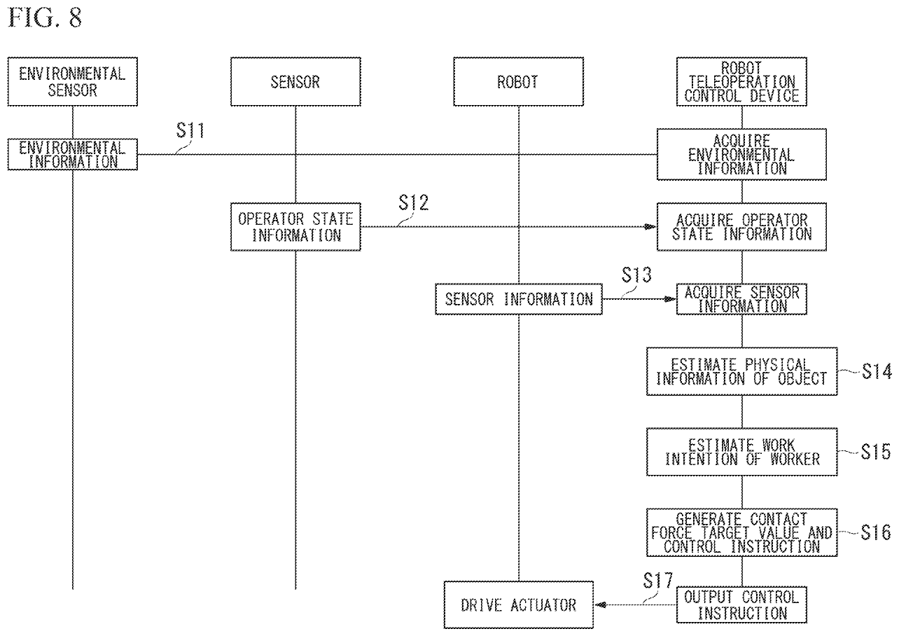

FIG. 8 is a sequence diagram illustrating an example of a processing procedure of the robot teleoperation control system 100 according to the present embodiment.

(Step S11) The second acquisition unit 202 of the robot remote control device 200 acquires environmental information from the environmental sensor 300.

(Step S12) The first acquisition unit 201 of the robot remote control device 200 acquires operator state information of the operator sensor 400.

(Step S13) The second acquisition unit 202 of the robot remote control device 200 acquires sensor information from the sensor 36 of the robot 1.

(Step S14) The object information estimation unit 203 of the robot remote control device 200 uses the information acquired by the second acquisition unit 202 to refer to information stored in the object information DB 204 and to estimate and acquire at least one of geometric information and dynamic information of an object to be operated.

(Step S15) The intention estimation unit 205 of the robot remote control device 200 estimates the intention of a worker using the information acquired by the first acquisition unit 201 and the information acquired by the second acquisition unit 202.

(Step S16) The control amount determination unit 207 of the robot remote control device 200 determines a method of operating a robot and force during operation from the information acquired by the second acquisition unit and the information determined by the operation method determination unit, and reflects the result in a control instruction.

(Step S17) The control amount determination unit 207 of the robot remote control device 200 transmits the reflected control instruction to the robot 1. The robot 1 drives the actuators 21 and 22 in accordance with the control instruction. The processing procedure described with reference to FIG. 8 is an example, and there is no limitation thereto. For example, the order of processes of steps S11 to S13 may be different or may be performed in parallel.

As described above, in the present embodiment, the geometric information and dynamic information (such as shape, mass, Young's modulus, and friction) of an object are estimated through information of sensors (force sensor, torque sensor, and image sensor) installed in the robot 1 and the environment. For the estimation, external force estimation using a force sensor and a torque sensor, classification based on machine learning, and a database are used.

In the present embodiment, the intention of an operator is estimated from information of sensors (RGB image, depth, gyro, line of sight, and the like) installed in the robot 1, the environment, and the operator, and the object, its point of contact, and taxonomy are estimated.

In the present embodiment, the robot teleoperation control device 200 estimates the optimum contact force on the basis of the information and reflects the result in a control instruction. That is, in the present embodiment, the robot teleoperation control device 200 generates an appropriate contact force target on the basis of, for example, the shape, mass, Young's modulus, and friction coefficient of an object, and the result of estimating an intention to grab the object, for example, from the side. Thereby, according to the present embodiment, the operator can work without considering force applied to an object and gravity applied from the object.

Thereby, according to the present embodiment, a teleoperated robot can grasp or operate various objects with an appropriate force. Thereby, according to the present embodiment, improvement in work efficiency and an increase in the number of types of work are expected.

The intention estimation unit 205 may predict the future trajectory of the hand intended by the operator in advance on the basis of the operator state information and the state information of the robot 1.

The robot 1 described above may be, for example, a bipedal walking robot, a stationary reception robot, or a working robot.

In the above-described example, although an example in which the robot 1 is caused to perform grasping through remote operation has been described, the present invention is not limited thereto.

In the above-described example, although an example in which the operator wears the HMD 501 has been described, the present invention is not limited thereto. The detection of line-of-sight information and the provision of a robot state image to the operator may be performed by, for example, a combination of a sensor and an image display device, or the like.

A program for realizing all or some of functions of the robot teleoperation control device 200 in the present invention is recorded in a computer readable recording medium, and thus all or some of processes performed by the robot teleoperation control device 200 may be performed by causing a computer system to read and execute the program recorded in this recording medium. The term “computer system” referred to here is assumed to include an OS and hardware such as peripheral devices. The “computer system” is also assumed to include a WWW system provided with a homepage providing environment (or a display environment). The term “computer readable recording medium” refers to a flexible disk, a magneto-optic disc, a ROM, a portable medium such as a CD-ROM, and a storage device such as a hard disk built into the computer system. Further, the “computer readable recording medium” is assumed to include recording mediums that hold a program for a certain period of time like a volatile memory (RAM) inside a computer system serving as a server or a client in a case where a program is transmitted through networks such as the Internet or communication lines such as a telephone line.

The above-mentioned program may be transmitted from a computer system having this program stored in a storage device or the like through a transmission medium or through transmitted waves in the transmission medium to other computer systems. Here, the “transmission medium” that transmits a program refers to a medium having a function of transmitting information like networks (communication networks) such as the Internet or communication channels (communication lines) such as a telephone line. The above-mentioned program may realize a portion of the above-mentioned functions. Further, the program may be a so-called difference file (difference program) capable of realizing the above-mentioned functions by a combination with a program which is already recorded in a computer system.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A robot teleoperation control device comprising:
a first acquisition unit that acquires operator state information of a state of an operator who operates a robot capable of grasping an object in robot teleoperation control in which the operator remotely operates the robot;
an intention estimation unit that estimates an intention of the operator to cause the robot to perform a motion on the basis of the operator state information;
a second acquisition unit that acquires at least one of geometric information and dynamic information of the object;
an operation method determination unit that determines a method of operating the object based on the estimated motion intention of the operator; and
a control amount determination unit that determines a method of operating the robot and force during operation from the information acquired by the second acquisition unit and information determined by the operation method determination unit and reflects the result in a control instruction.

2. The robot teleoperation control device according to claim 1, wherein the second acquisition unit acquires at least one of a shape, mass, Young's modulus, rigidity, and frictional force of the object.

3. The robot teleoperation control device according to claim 1, wherein the second acquisition unit acquires environmental information including an image including the object and position information of the object, and sensor information detected by a sensor provided in the robot to detect information related to the motion of the robot.

4. The robot teleoperation control device according to claim 1, wherein the second acquisition unit acquires at least one of the geometric information and dynamic information of the object through at least one of estimating an external force using a force sensor and a torque sensor provided in the robot, classification using a trained learning model, and referring to a database that stores information relating to the object.

5. The robot teleoperation control device according to claim 1, wherein the intention estimation unit estimates a name of the object, operation content for the object, and a point of contact between the robot and the object when the object is operated.

6. A robot teleoperation control method comprising:
causing a first acquisition unit to acquire operator state information of a state of an operator who operates a robot capable of grasping an object in robot teleoperation control in which the operator remotely operates the robot;
causing an intention estimation unit to estimate an intention of the operator to cause the robot to perform a motion on the basis of the operator state information;
causing a second acquisition unit to acquire at least one of geometric information and dynamic information of the object;
causing an operation method determination unit to determine a method of operating the object based on the estimated motion intention of the operator; and
causing a control amount determination unit to determine a method of operating the robot and force during operation from the information acquired by the second acquisition unit and information determined by the operation method determination unit and reflect the result in a control instruction.

7. A computer readable non-transitory storage medium that stores a program for causing a computer to function as the robot teleoperation control device according to claim 1.
